(19) United States
(12) Patent Application Publication
(10) Pub. No.: US 2004/0227011 A1
(43) Pub. Date: Nov. 18, 2004

(54) Spray nozzle capable of accommodating liquid inhalation dose

(76) Inventor: Daniel C.M. Tseng, Taipei Hsien (TW)

Correspondence Address: BIRCH STEWART KOLASCH & BIRCH, PO BOX 747, FALLS CHURCH, VA, 22040-0747, US

(21) Appl. No.: 10/424,787

(22) Filed: Apr. 29, 2003

(51) Int. Cl. B05B 9/03

(52) U.S. Cl. 239/302; 239/338; 239/340

(57) ABSTRACT

A disposable spray nozzle capable of accommodating liquid dose installed in a medical compressor nebulizer or connected to a device of other pressure sources, comprises a dose container and a spray nozzle; the dose container has a guide duct and an unsealing section connected to the guide duct disposed at the opening end of the guide duct. The spray nozzle is disposed on the guide duct of the dose container, and has a dose accommodating space in the dose container; a first opening section and a second opening section are disposed on both ends of the dose accommodating space and sealed respectively by a sealing section, such that the dose as well as the disposable spray nozzle can be inserted directly into the guide duct of the dose container. The unsealing section at the end of the guided duct pierces through the sealing section of the first and second opening sections of the spray nozzle, so that the liquid dose seeps out for the nebulizing operation.

### FIELD OF THE INVENTION

The present invention relates to a disposable spray nozzle capable of accommodating liquid dose, more particularly a spray nozzle capable of accommodating liquid dose using a simple operating procedure to prevent contaminations or residual dose from incomplete cleaning of the spray nozzle after use.

### BACKGROUND OF THE INVENTION

The modern popular pathology shows that over 70% of the human diseases relate to the environment, and it is the most significant factor affecting human health, especially the respiratory system. Dry air causes our respiratory system to have a large quantity of water loss, a poor secretion of mucus, and a reduction of fine hair movement, etc. The original human body protection strength is weakened greatly and the immunity is lowered drastically, which leads to diseases in our respiratory system. In addition, it accompanieswithsymptoms such as weariness, reduction of vision, and dizziness. Conventionally, it is necessary to open the liquid dose before using the prior-art medical compressor nebulizer, and then the liquid dose is poured into a dose container. The position should be aligned during the pouring procedure of the liquid dose to prevent seeping of the dose, and that is very troublesome. Furthermore, the dose container and the spray nozzle must be cleaned completely after each time of use to get ready for the next use. Particularly, if the spray nozzle is not cleaned completely, a dirty spray nozzle may have germ contamination and residual dose that will affect the quality and spraying effect in the future.

### SUMMARY OF THE INVENTION

The primary objective of the present invention is to solve the aforementioned problems and eliminate the drawbacks of cited prior art. The present invention relates to a disposable spray nozzle capable of accommodating doses and working together with the dose container to simplify the operating procedure and avoid germ contaminations and residual dose which will affect the quality and spraying effect of filling the dose for next use.

### BRIEF DESCRIPTION OF THE DRAWINGS

FIG. 1 is a perspective diagram of the present invention.

FIG. 2 is a cross-sectional diagram of the present invention.

FIG. 3 is an illustrative diagram of the disposition of the dose container of the present invention.

FIG. 4 is a cross-sectional diagram of the disposition of the dose container of the present invention.

FIG. 5 is an illustrative diagram of the interior of a medical compressor nebulizer of the present invention.

FIG. 6 is an illustrative diagram of the present invention being used for the external pressure source.

### DETAILED DESCRIPTION OF THE PREFERRED EMBODIMENTS

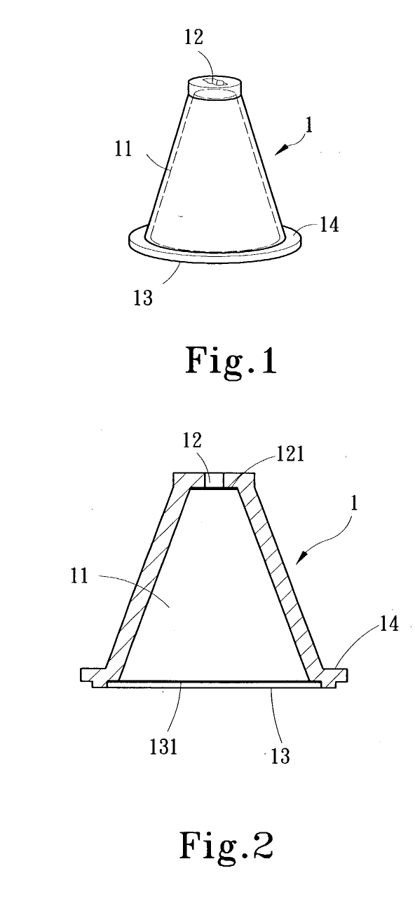

Please refer to FIGS. 1 and 2 for the perspective diagram and the cross-sectional diagram of the present invention respectively. In the figures, a spray nozzle capable of accommodating liquid dose comprises a dose accommodating space 11, a first opening section 12 and a second opening section 13 respectively disposed on both ends of said dose accommodating space 11, sealing sections 121, 131, which could be a thin film for sealing said first and second opening sections 12, 13, and a fixing section 14 disposed around the periphery of said second opening section 13.

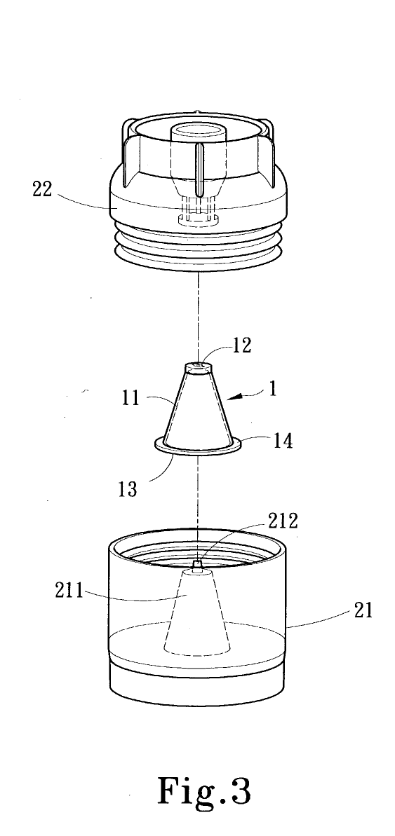

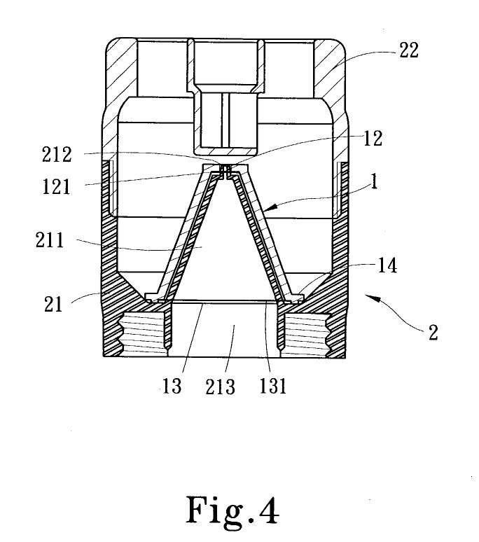

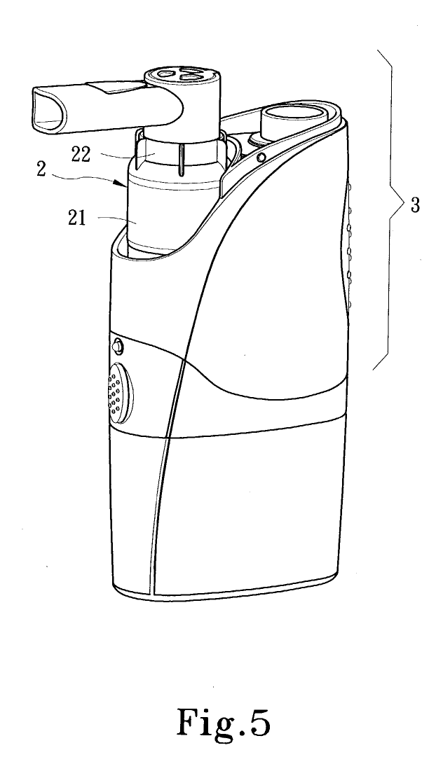

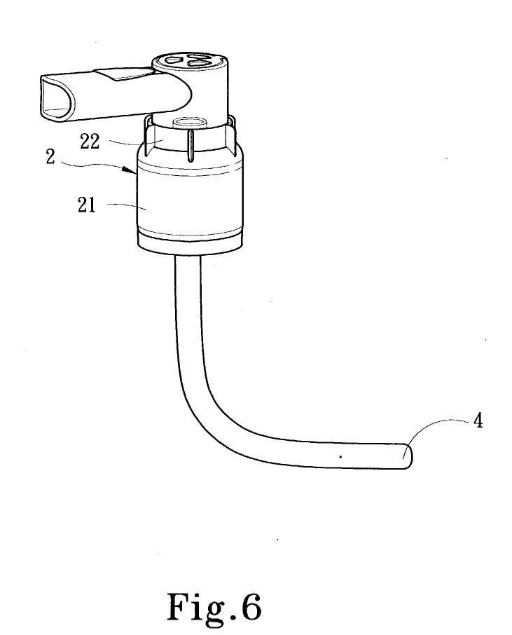

Please refer to FIGS. 3, 4, 5, and 6 for the illustrative diagram of the disposition of the dose container of the present invention and the cross-sectional diagrams of the present invention when used in the medical compressor nebulizer or the external pressure source. In the figures, the spray nozzle capable of accommodating liquid dose is a device installed in the interior of a medical compressor nebulizer 3 or connected to an external pressure source 4 for accommodating liquid dose. Such device comprises a dose container 2, a spray nozzle 1 disposed in the interior of said dose container 2 and containing a specific liquid dose; said dose container 2 comprises an accommodating base 21, a cover 22, a guide duct 211 disposed in said accommodating base 21, a passage 213 disposed in said guide duct 211, and said passage 213 being connected to an internal air compressing device (not shown in the figure) of the medical compressor nebulizer 3 or an external pressure source 4, and an unsealing section 212 disposed at the top of said guide duct 211.

Users only need to insert the spray nozzle 1 containing a liquid dose directly into the guide duct 211 at the center of the accommodating base 21 of the dose container 2 and allow the guide duct 211 to pierce through the sealing section 131 of the second opening section 13 of the spray nozzle 1, and the unsealing section 212 at the top of the guide duct 211 to pierce through the sealing section 121 of the first opening section 12 of the spray nozzle 1. Finally, after the fixing section 14 is fixed onto the outer periphery of the guide duct 211, the liquid dose contained in the dose accommodating space 11 is released and the medical compressor nebulizer 3 is started. By means of the pressure difference principle, the liquid dose in the spray nozzle is sprayed out for the patient's inhalation.

Therefore, with the design of the present invention, the disposable spray nozzle 1, capable of accommodating liquid dose in accordance with the present invention, can be installed directly inside the dose container 2 for the spraying operation, which effectively simplifies the operation procedure and prevents the nozzle from being contaminated by external germs or affected by residues if the spray nozzle 1 is not cleaned thoroughly after its use.

What is claimed is:

1. A spray nozzle capable of accommodating liquid dose, being a device installed in a medical compressor nebulizer or connected to an external pressure source for accommodating a liquid dose, comprises:
a dose container, further comprises an accommodating base, a cover, a guide duct disposed in said accommodating base, and a sealing section disposed at an opening end of the guide duct of said accommodating base and connected to said guide duct;
a disposable spray nozzle, being disposed on the guide duct of said dose container and having a dose accommodating space in said spray nozzle, a first opening section and a second opening section being disposed respectively on both ends of said dose accommodating space, and a sealing section for sealing each of said first and second opening sections; thereby the spray nozzle containing the liquid dose being inserted directly into the guide duct of the accommodating base of said dose container; the unsealing section at the end of the guide duct pierces through the sealing section of the first opening section of the spray nozzle; the dose seeping out for the spraying operation; and thus effectively simplifying the operation procedure and preventing the spray nozzle from being contaminated by external germs or residual dose.

2. The spray nozzle capable of accommodating liquid dose of claim 1, wherein said spray nozzle has a fixing section around its bottom.

3. The spray nozzle capable of accommodating liquid dose of claim 1, wherein said sealing section is a thin film.
